(19) United States
(12) Patent Application Publication
(10) Pub. No.: US 2014/0251694 A1
(43) Pub. Date: Sep. 11, 2014

(54) Directional Boring Tooling Reed Type Checkflow Valve

(71) Applicant: Earth Tool Company LLC, Oconomowoc, WI (US)

(72) Inventor: Robert F. Crane, Oconomowoc, WI (US)

(73) Assignee: Earth Tool Company LLC, Oconomowoc, WI (US)

(21) Appl. No.: 14/196,834

(22) Filed: Mar. 4, 2014

Related U.S. Application Data
(60) Provisional application No. 61/774,829, filed on Mar. 8, 2013.

(51) Int. Cl. E21B 7/04; F16L 15/00

(52) U.S. Cl. CPC E21B 7/046; F16L 15/00
USPC 175/73; 137/315.11

(57) ABSTRACT

A pipe joint used in horizontal direction drilling operations having a removable valve assembly secured between the pin of a first member and the socket of a second member. The valve assembly reduces backflow of drilling fluid uphole of the downhole tool and reduces the risk of malfunction due to clogging of tooling.

### CROSS REFERENCE TO RELATED APPLICATION

This application claims the benefit of provisional patent application Ser. No. 61/774,829, filed on Mar. 8, 2013, the entire contents of which are incorporated herein by reference.

### FIELD

The present invention relates generally to horizontal directional drilling, and in particular to flow valves used in downhole tooling.

### SUMMARY

The present invention is directed to a pipe joint comprising a first member, a second member and a removable valve assembly. The first member comprises a socket having an internal face and a first fluid passage. The second member comprises a pin formed to fit within the socket of the first member and a second fluid passage that communicates with the first fluid passage. The removable valve assembly controls the flow of fluid between the first fluid passage and the second fluid passage and is supported in the socket. It is held in place when the pin of the second member is positioned within the socket of the first member.

The present invention is further directed to pipe joint comprising a first member, a second member, and a removable valve assembly. The first member comprises a pin and a first fluid passage. The second member comprises a socket formed to receive the pin of the first member and a second fluid passage that communicates with the first fluid passage. The removable valve assembly controls the flow of fluid between the first fluid passage and the second fluid passage and is supported in the socket. The valve assembly is held in place when the pin of the first member is positioned within the socket of the second member.

The present invention is likewise directed to a horizontal directional drilling system. The system comprises a rotary drive, a drill string, a pipe joint, and a downhole tool. The drill string has a first end, a second end, and a fluid passage extending between the first end and the second end. The first end is operatively connected to the rotary drive. The pipe joint is connected to the second end of the drill string and comprises a first member, a second member, and a valve assembly. The first member is connected to the second end of the drill string and comprises a socket having an internal face and a first fluid passage in fluid communication with the fluid passage of the drill string. The second member comprises a pin formed to fit within the socket of the first member and a second fluid passage that communicates with the first fluid passage. The removable valve assembly controls the flow of fluid between the first fluid passage and the second fluid passage and is supported in the socket between the internal face and the pin when the pin is positioned within the socket. The downhole tool is operatively connected to the second member and has a fluid outlet in communication with the second fluid passage.

### BRIEF DESCRIPTION OF THE DRAWINGS

FIG. 1 is an overall view of a horizontal directional drilling (“HDD”) operation.

FIG. 2 is a side view of a HDD downhole tool and the pipe joint of the present invention.

FIG. 3 is a close-up side view of the pipe joint shown in FIG. 2.

FIG. 4 is a sectional view of the pipe joint of FIG. 3 along line A-A showing a valve and valve seat positioned within the pipe joint.

FIG. 5 is an isometric view of the valve seat of FIG. 4.

FIG. 6 is an isometric view of the valve shown in FIG. 4.

FIG. 7 is a side section view of a downhole tool and pipe joint of FIG. 2.

FIG. 8 is a side view of an alternative pipe joint.

FIG. 9 is a sectional view of the pipe joint of FIG. 8 along line B-B.

### DESCRIPTION

Directional boring machines are used to drill holes underneath roads and other obstructions for the installation of gas lines, telephone and electrical cable and other utilities. In the past, installing a gas line or electrical cable across, for example a roadway, required excavation of a trench through which the utility line was installed. After installation, the trench was backfilled with appropriate material, such as sand or crushed rock, in a series of stages. A layer of fill material was placed in the trench and tamped down, either manually or with a mechanical tamping device. This process was repeated until the trench was filled to a level close to the surface. At this point, the surface of the roadway would be resurfaced with gravel, asphalt, or concrete, depending upon the particular circumstances.

The development of the horizontal directional drilling has largely eliminated the need to trench across roads or other surface structures. The HDD system 10 comprises a rotary drive rig 20, a drill string 22, a pipe joint assembly 23, and a downhole tool 25. The drill string 22 generally comprises a series of pipe sections joined end to end at threaded connections. The drill string has a first end 26 operatively connected to the rotary drive 20 and a second end 28. The drill string 22 passes through the borehole 24 as the downhole tool 25 is advanced to the exit point. The drill string 22 may be tubular and comprise a fluid passage (not shown) that extends between the first end 26 and the second end 28. The pipe joint assembly 23 is connected to the second end 28 of the drill string and will be discussed in greater detail hereinafter. The downhole tool 25 is operatively connected to the pipe joint assembly in a manner discussed hereinafter. The downhole tool 25 may comprise a drill bit or head configured for boring and typically includes an ejection nozzle for water or drilling mud to assist in boring.

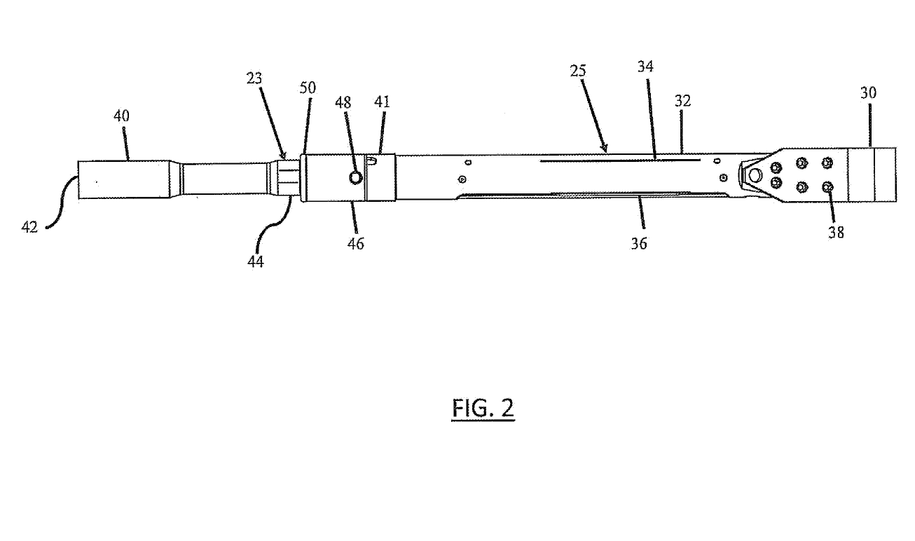

Turning now to FIG. 2, the pipe joint assembly 23 and downhole tool 25 of the present invention are shown. The downhole tool 25 may comprise a drill bit 30 and transmitter housing 32 attached to the pipe joint assembly 23. A sensor and transmitting device known as a transmitter or beacon (not shown) is located within the transmitter housing 32. The transmitter housing is generally made from steel. Therefore the housing 32 may have one or more slots 34 formed therein to allow the beacon signal to pass through the housing. A door 36 may be disposed on the side of the housing 32 to allow access to the beacon. Alternatively, the beacon may be loaded into the housing from the end of the housing. In the embodiment of FIG. 2 the drill bit 30 is connected to the housing 32 using a plurality of fasteners 38. However, one skilled in the art will appreciate that a drill bit, such as a tricone bit or a back reamer could be connected to the housing 32 using known threaded connections.

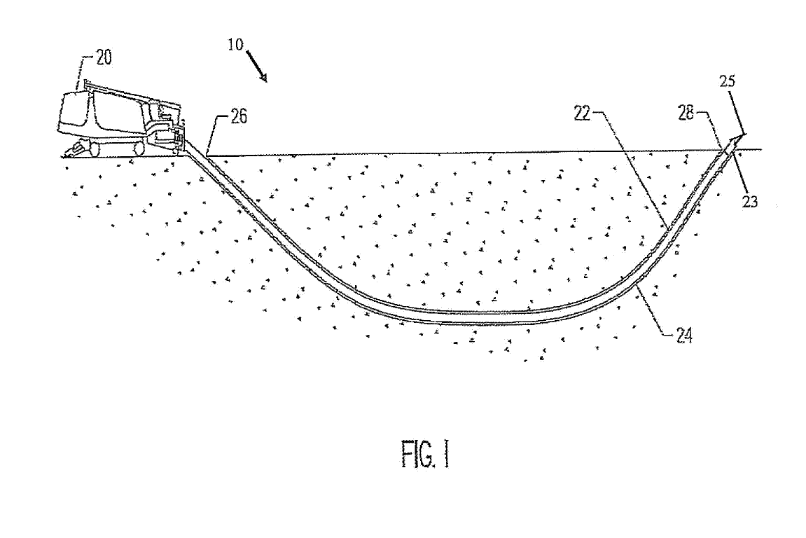

Referring to FIGS. 1 and 2, as the machine 20 is operated to bore through the earth additional drill string sections, or rods, are added as the drill bit 30 moves further away from the machine that drives it. The downhole tool 25 and pipe joint assembly 23 eventually emerge at the end of the run at an exit pit or site. The drill bit 30 and transmitter housing 32 may then be decoupled from pipe joint assembly 23 and replaced by a back reamer, which is then drawn backwards through the initial bore in order to widen it.

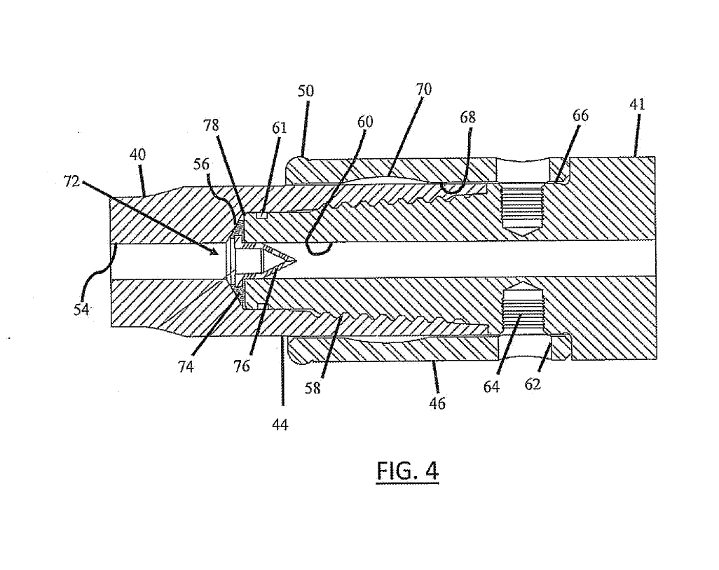

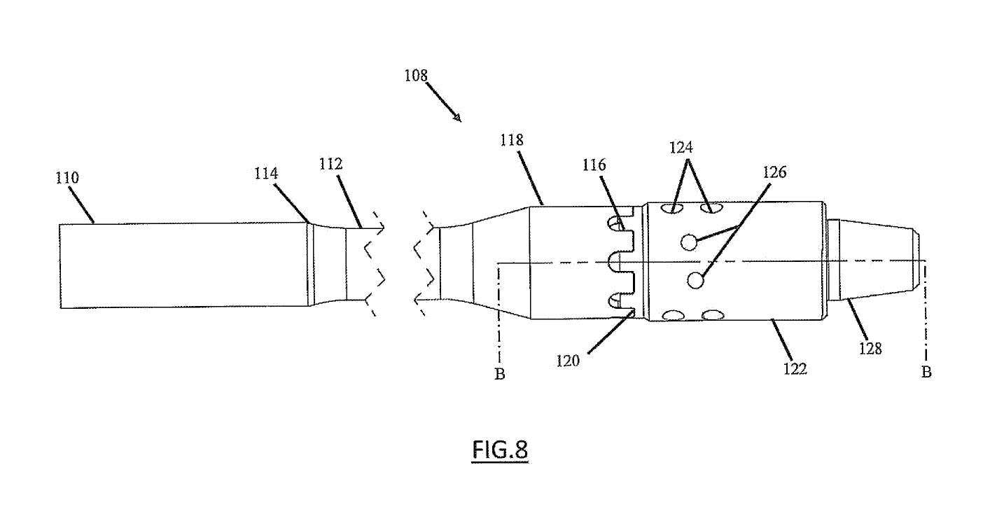

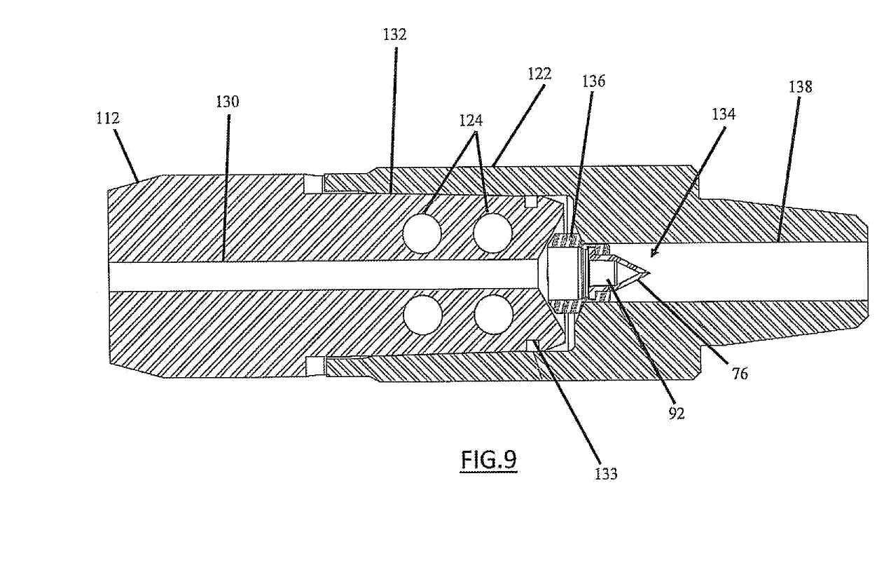

Decoupling the drill bit 30 and transmitter housing 32, reamer or other tooling from a starter rod 40 may be difficult. One system for disconnecting starter rod and transmitter housing is a hex or octagon collar connection that can be disassembled easily but still requires rotation of the bit or reamer to accomplish assembly or disassembly. According to this approach, a front end of the starter rod is coupled directly to a threaded male or female feature at the end of the leading drill rod. The other end makes up a convenience joint and has a threaded recess that engages a threaded projection at the rear end of the transmitter housing. The outer surface of the rear end of the starter rod has a hex or octagon shape which matches mating components on the transmitter housing or other tooling. The tooling is threaded onto the starter rod and tightened to the point where the hex (or octagon) surfaces line up, which is just short of full tightness. Then a sleeve for passing torque having a hex (or octagon) shaped opening is slid over both surfaces and secured in place using a set screw. This system is shown in FIGS. 2 and 4. In another system, shear pins are used to transmit tensile forces and a face spline transmits torque and thrust. Such a system is shown in FIGS. 8 and 9.

Whether attached to a pilot boring drill head or a bore opening expander, the tooling is stopped to allow drill string section changes. During these changes, the positive fluid pressure in the pipe joint assembly, the downhole tool, and drill string relative to the ambient pressure about the downhole tooling in the borehole reverses. During this time period contaminated drill fluid, bentonite, polymer or ground water mixed with the cuttings from the rock or soil in the bore are permitted to flow back into the downhole tooling. This backflow may cause clogging of nozzles used to eject fluid into the borehole.

With the reversed pressure ratio, solids from the boring operation may flow into the downhole tooling when the mudflow is stopped for the addition or removal of a pipe section. Therefore a way to stop the backflow is best applied near the nozzle formed in the downhole tool to limit the amount of backflow or stop it all together. As many back reamers have a multitude of discharge nozzles of which may be external and therefore prone to abrasive wear, it is problematic to put a check valve in each nozzle. Rather, a serviceable location adjacent the bit or back reamer is the ideal location to place a check valve. Further, such a location would best be accessed on a regular basis for service and removal of any debris that backflows to the valve.

Drilling fluids generally contain some form of solids. Thus, when drilling fluid remains in the downhole tooling and dries out, the solids become caked and typically adhere to the walls of the flow passages within the tooling. The caked material may prevent certain valve configurations from operating properly. This may cause excessive heat exposure to electronics and/or wear on cutting surfaces of the bit 30.

To prevent the likelihood of an encrusted valve, the present invention may comprise a flexible orifice valve within a pipe joint. The flexible orifice valve can be rinsed or removed for cleaning upon the joint being retired from drilling for the day. If it isn't serviced, then the flexible nature of the valve will facilitate small flows until downstream caking has been dissolved. By incorporating this type of check valve in the drilling system, downtime due to electronic transmitter failure, premature wear of tooling or the consequences of lost bores can be avoided.

Continuing now with FIG. 2, the pipe joint assembly 23 comprises a first member 40 connected to the second end of the drill string and a second member 41 connected to the first member. In some applications the first member 40 may be referred to as the starter rod. The downhole tool 25 may comprise a transmitter housing 32 connected to the second member 41.

The first member 40 may have a threaded box end 42 which would be coupled to a series of pipe sections comprising the drill string 22 (FIG. 1) leading back to the rotary drive 20 (FIG. 1). Box end 42 comprises an upset to facilitate a sufficient wall in the female thread that may be tightened to the male thread of the last drill string pipe section. The opposite end of the first member 40 may comprise a socket 44. The socket 44 of the first member 40 may comprise a non-circular exterior surface. The non-circular surface may comprise a geometric shape such as an octagon to form a series of outside surface flats.

A sleeve 46 having a non-circular profile on an inner surface thereof that matches the non-circular exterior surface 44 of the first member 40. The sleeve 46 can be slidably mounted on the non-circular exterior surface of the first member 40 and fastened to the second member 41 using fastener 48 so that the sleeve passes torque from the first member 40 to the second member 41. The sleeve 46 may have a wear edge 50 that is hard-face welding to minimize abrasive wear to the sleeve when the pipe joint assembly 23 moves left as shown in FIG. 2.

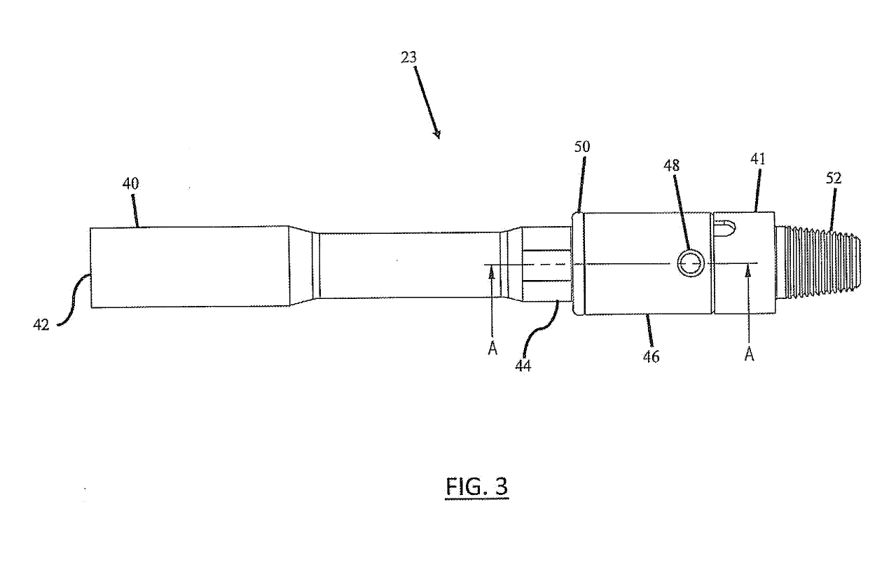

Turning now to FIG. 3, the pipe joint 23 of the present invention is shown. As discussed above, the pipe joint comprises a first member 40 and a second member 41. FIG. 3 shows that the second member 41 may comprise a threaded pin end 52 used to make a torque transmitting connection with beacon housing 32. One skilled in the art will appreciate that second member 41 may be integrated with the beacon housing 32 to form a single piece without departing from the spirit of the invention. Further, connection 52 may comprise an internally threaded box end or any other connection configuration allowing torque transmission between the second member and the downhole tooling.

Referring, now to FIG. 4, there is shown therein a sectional view of the pipe joint shown in FIG. 3 along line A-A. The first member 40 comprises a first fluid passage 54 that is in fluid communication with the fluid passage of the drill string 22 (FIG. 1) and socket 44. Socket 44 has an internal face 56. Internal face may slope toward the first fluid passage 54 as shown in FIG. 4, or may be orthogonal to the external surface of the socket. The internal face 56 defines an opening of the first fluid passage 54 into the socket 44.

The second member 41 comprises a pin 58 formed to fit within the socket 44 of the first member 40. The second member 41 also comprises a second fluid flow passage 60 that communicates with the first fluid flow passage 54. A portion of pin 58 of the second member may be threaded to correspond to internal threads formed on the internal surface of socket 44. Of course, a threaded connection is not required and a geometric connection may be used to transfer torque between the first member 40 and the second member 41. A seal groove 61 may be formed on the pin of the second member to restrict fluid from flowing outside the pipe joint. As discussed above, sleeve 46 may be mounted on the exterior surface of the first member 40 and the second member 41. The sleeve is held in place using a shear bolt 48 (FIG. 2) passed through lock screw hole 62 and secured with lock screw threads 64 of second member 41. The pin 58 may comprise an external non-circular surface 66 corresponding to the non-circular surface 44 of the first member 40 and the non-circular profile 68 of the sleeve 46. A fluid channel 70 may be formed between the internal profile 68 and the socket 44.

Continuing with FIG. 4, a removable valve assembly 72 is shown supported in the socket 44 and held in place by the pin 58 of the second member 41. The removable valve assembly 72 controls the flow of fluid between the first fluid passage 54 and the second fluid passage 60. The valve assembly 72 is held in place when the pin 58 of the second member 41 is positioned within the socket 44 of the first member 40. This location of the valve assembly 72 is beneficial because it allows an operator access to the valve assembly for cleaning, maintenance and replacement when needed without requiring the complicated dismantling of several parts or pieces.

The removable valve assembly 72 may comprise a valve seat 74 and a valve 76. The valve seat 74 is secured in the socket 44 between the internal face 56 and the terminal end 78 of the pin 58. The terminal end 78 of the pin 58 defines an opening of the second fluid passage. The valve seat 74 will be discussed later in more detail. The valve 76 is seated in the valve seat 74 and disposed between the first fluid passage 54 and the second fluid passage 60 to permit the flow of fluid from the first passage to the second passage and reduce or prevent the flow of fluid from the second passage to the first passage.

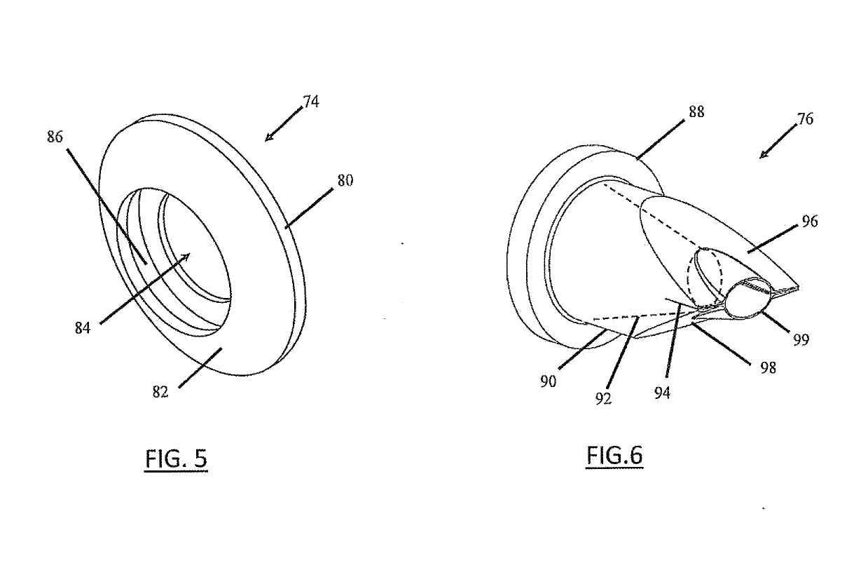

As shown in FIG. 5, valve seat 74 is generally shaped like a ring having a circular outer surface 80, a socket face 82, a fluid passage hole 84, and a valve groove 86. The circular outer surface 80 of valve seat 74 is configured to fit within the socket 44 and, as shown in FIG. 4, may be sized to contact the internal face 56 and not contact the walls of the socket 44. The socket face 82 is configured to fit snug against the internal face 56 of the socket to prevent the leakage of drilling fluid between the internal face and the socket face. In the embodiment of FIGS. 4 and 5 the socket face 82 is frustoconical to match the slope of the internal face 56 of the socket and not close or restrict the opening of the first fluid passage 54. Valve groove 86 is formed internally on valve seat 74 and provides the seat for the valve.

Turning to FIG. 6, the valve 76 of the present invention is shown and may comprise a diaphragm valve. The valve 76 comprises a flange 88 having an opening (not shown). The flange 88 is formed to fit within valve groove 86 of the valve seat 74 (FIG. 5). A cylindrical extension 90 extends from the flange 88 and defines a circular cavity 92. The circular extension 90 extends into the second fluid passage 60 (FIG. 4) when positioned for use in the pipe joint assembly. A slot 94 is formed at an end of the circular extension 90 opposing the flange 88. The slot 94 opens, as shown in FIG. 6, when fluid in the first fluid passage 54 (FIG. 3) reaches a threshold pressure sufficient to cause sides 96 and 98 of the slot 94 to deform and open the valve to allow fluid into the second fluid passage 60 (FIG. 3). When the fluid pressure in the first fluid passage 54 decreases below the threshold due to low volume of fluid or the operator shutting off the uphole drilling fluid pump, the sides 96 and 98 resume their resting flat shape and close off valve 30. The valve 76 is preferably formed from neoprene with a soft durometer of shore A70 or less. The cylindrical extension 90 is of greater structural section than sides 96 and 98 and will cause slot 94 to gap open and pass the fluid.

FIG. 6 shows walls 96 and 98 deformed under pressure causing slot 94 to gap open creating opening 99 through which fluid may flow. In the event drilling fluid is not removed from the first and second fluid passages during clean-up or at the end of a day of drilling, dried solids will likely cake in the annular space between cylindrical extension 90 and the second passage 60. The, walls 96 and 98 need only deform slightly under distortion to produce opening similar in form to opening 99, though the exact shape and location will be determined by the caked solids location and the elastic nature of valve 76. This flexibility to produce an opening despite the adverse conditions of dried drilling fluid downstream of the valve is advantageous.

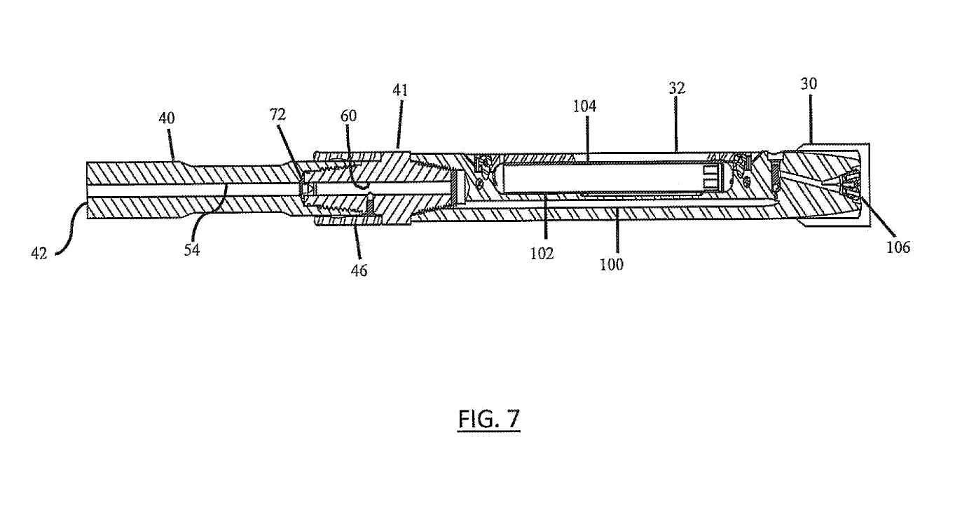

In operation drilling fluid enters the first fluid passage 54 of the first member from the left in FIG. 7 and flows towards valve assembly 72. Valve assembly 72 is held in place between the internal face 56 of the socket 44 of the first member and the terminal end 78 of the pin of the second member 41. When a threshold fluid pressure is reached the valve 76 (FIG. 6) will open and allow fluid to pass into the second fluid passage 60. The fluid will continue to the left along the second fluid passage 60 and into a beacon housing passage 100 running from an uphole end of the beacon housing 32 to the downhole end. The beacon housing passage 100 is formed proximate a beacon cradle 102 to cool the beacon 104 during drilling operations. The beacon housing passage 100 terminates in a series of ejection nozzles 106 disposed at the downhole end of the housing. The nozzles 106 eject fluid from the housing 32 to assist in the boring operation and lubricate and cool the cutting elements and the beacon housing 32. Thus, during boring the borehole has a significant amount of drilling fluid that is located in the annulus between the drill string, downhole tooling, and drill bit and the borehole. Accordingly, when the drilling fluid pump is shut off drilling fluid flows back into the beacon housing 32 and other tooling through any available opening. Prior art systems have attempted to prevent this by placing check valves at every ejection nozzle in the downhole tool. The present invention eliminates the need for check valves at every nozzle by locating the valve assembly between the first member 40 and the second member 41. When the drilling fluid pump is shut off during boring operations the valve will close in response to the drop in pressure in the first fluid passage 54 and prevent the backflow of fluid past the valve assembly 72.

Turning now to FIG. 8, an alternative embodiment of the pipe joint 108 of the present invention is shown. The embodiment of FIG. 8 is an unthreaded pipe joint 108. One such pipe joint may comprise a SplineLok® as shown without tooling or drill string section attached thereto. As a full working assembly, the box end 110 of first member 112 would be coupled to a series of pipe sections leading back to the HDD rig 20. The box end has an upset 114 which comprises an enlargement to facilitate sufficient wall in the female thread that will be tightened to the male thread of the pipe section. Castellated feature 116 of pin end 118 on the first member 112 is a series of face splines that match grooves 120 on the second member 122. Solid shear pins (not shown) fill aligned holes 124. Spring pins are driven into shear pin holes 126 to restrain the shear pins. The second member 122 may have a pin end 128 to attach to various HDD tooling such as drill heads and back reamers.

FIG. 9 is a partial section view along line B-B of FIG. 3. The first member 112 comprises a first fluid passage 130 and a pin 132. Groove 133 may hold an O-ring to seal the pin 132 and the socket 135 of the second member 122 to prevent leakage of the drilling fluid into the bore. The first fluid passage 130 passes between shear pin holes 124. The first fluid passage 130 leads to an alternative valve assembly 134 having valve 76 which is shown located in alternative valve seat 136. Pressurized drilling fluid flowing through first fluid passage 130 will enter the valve cavity 92, thereby creating differential pressure between cavity 92 and the second fluid passage 138. This differential pressure will cause sidewalls 96 and 98 (FIG. 6) of valve 76 to deform allowing fluid to flow into passage 138. During times when lower fluid pressure exists in the first fluid passage 130 and higher fluid pressure in the second fluid passage 138, flow to the left will not be allowed due to the tendency of the pressure to close sidewalls 96 and 98 of valve 76.

Various modifications can be made in the design and operation of the present invention without departing from the spirit thereof. Thus, while the principle preferred construction and modes of operation of the invention have been explained in what is now considered to represent its best embodiments, which have been illustrated and described, it should be understood that the invention may be practiced otherwise than as specifically illustrated and described.

What is claimed is:

1. A pipe joint comprising:
a first member comprising:
a socket having an internal face; and
a first fluid passage;
a second member comprising:
a pin formed to fit within the socket of the first member; and
a second fluid passage that communicates with the first fluid passage; and
a removable valve assembly, to control the flow of fluid between the first fluid passage and the second fluid passage, supported in the socket and held in place when the pin of the second member is positioned within the socket of the first member.

2. The pipe joint of claim 1 wherein the first member comprises an internal face defining an opening of the first fluid passage.

3. The pipe joint of claim 1 wherein the socket of the first member comprises internal threads.

4. The pipe joint of claim 3 wherein the pin of the second member comprises external threads corresponding to the internal threads of the socket.

5. The pipe joint of claim 3 wherein a portion of the pin comprises external threads corresponding to the internal threads of the socket.

6. The pipe joint of claim 5 further comprising a seal groove formed in the pin of the second member.

7. The pipe joint of claim 5 wherein the external threads and the internal threads are tapered.

8. The pipe joint of claim 1 further comprising:
the first member having a non-circular exterior surface; and
a sleeve having a non-circular profile on an inner surface thereof whereby the sleeve can be slidably mounted on the non-circular exterior surface of the first member to transmit torque from the first member to the sleeve.

9. The pipe joint of claim 8 wherein the sleeve is fastened to the second member so that the sleeve passes torque to the second member.

10. The pipe joint of claim 1 wherein the valve assembly comprises:
a valve seat secured in the socket between the internal face and a terminal end of the pin, the terminal end of the pin defining an opening of the second fluid passage; and
a valve seated in the valve seat and disposed between the first fluid passage and the second fluid passage to permit the flow of fluid from the first passage to the second passage and reduce the flow of fluid from the second passage to the first passage.

11. The pipe joint of claim 10 wherein the valve prevents the flow of fluid from the second fluid passage to the first fluid passage.

12. The pipe joint of claim 1 wherein the valve assembly comprises a valve seat and valve disposed in the valve seat.

13. The pipe joint of claim 12 wherein the valve comprises a diaphragm valve.

14. The pipe joint of claim 12 wherein the valve comprises:
a flange disposed in the valve seat and having an opening;
a circular extension extending from the flange and defining a cavity in fluid communication with the opening of the flange; and
a slot formed at an end of the circular extension opposing the flange, wherein the slot opens, when fluid passing from the first fluid passage reaches a threshold pressure, to permit fluid to flow to the second fluid passage.

15. The pipe joint of claim 1 wherein the second member comprises a downhole tool.

16. The pipe joint of claim 15 wherein the downhole tool comprises a beacon housing and drill bit.

17. A pipe joint comprising:
a first member comprising:
a pin; and
a first fluid passage;
a second member comprising:
a socket formed to receive the pin of the first member; and
a second fluid passage that communicates with the first fluid passage; and
a removable valve assembly, to control the flow of fluid between the first fluid passage and the second fluid passage, supported in the socket and held in place when the pin of the first member is positioned within the socket of the second member.

18. The pipe joint of claim 17 wherein the first member comprises a pipe section having a socket at an end opposite the pin.

19. The pipe joint of claim 17 wherein the second member comprises a pin at an end of the second member opposing the socket.

20. The pipe joint of claim 17 wherein the socket comprises an internal face having an opening of the second fluid passage.

21. The pipe joint of claim 17 wherein the first member comprises a socket disposed at an end opposite the pin of the first member.

22. The pipe joint of claim 17 wherein the first member comprises a plurality of grooves disposed about an exterior surface of the first member.

23. The pipe joint of claim 22 wherein the socket of the second member comprises a plurality of splines corresponding to the grooves of the first member, such that the splines are disposed within the grooves to transmit torque between the first member and the second member when the pin end is disposed within the socket.

24. The pipe joint of claim 17 wherein the first member and the second member comprise a series of spline and groove connections.

25. The pipe joint of claim 17 further comprising:
the pin having a non-circular exterior surface portion;
the socket having a non-circular exterior surface corresponding to the non-circular exterior surface of the pin; and
a sleeve having a non-circular profile on an inner surface thereof whereby the sleeve can be slidably mounted on the non-circular exterior surfaces of the pin and socket.

26. The pipe joint of claim 25 wherein the sleeve is fastened to the first member so that the sleeve passes torque from the first member to the second member.

27. The pipe joint of claim 20 wherein the valve assembly comprises:
a valve seat secured in the socket between the internal face of the socket and a distal end of the pin; and
a valve seated in the valve seat and disposed between the first fluid passage and the second fluid passage to permit the flow of fluid from the first passage to the second passage and reduce the flow of fluid from the second passage to the first passage.

28. The pipe joint of claim 27 wherein the valve prevents the flow of fluid from the second fluid passage to the first fluid passage.

29. The pipe joint of claim 17 wherein the valve assembly comprises a valve seat and valve disposed in the valve seat.

30. The pipe joint of claim 29 wherein the valve comprises a diaphragm valve.

31. The pipe joint of claim 29 wherein the valve comprises:
a flange disposed in the valve seat and having an opening;
a circular extension extending from the flange into the second fluid passage and defining a cavity in fluid communication with the opening of the flange; and
a slot formed at an end of the circular extension opposing the flange and within the second fluid passage, wherein the slot opens, when fluid passing from the first fluid passage reaches a threshold pressure, to permit fluid to flow to the second fluid passage.

32. The pipe joint of claim 17 wherein the second member comprises a downhole tool having a fluid outlet in communication with the second fluid passage.

33. The pipe joint of claim 32 wherein the downhole tool comprises a back reamer.

34. A horizontal directional drilling system comprising:
a rotary drive;
a drill string having a first end, a second end, and a fluid passage extending between the first end and the second end, the first end operatively connected to the rotary drive;
a pipe joint connected to the second end of the drill string, the pipe joint comprises:
a first member connected to the second end of the drill string, the first member comprising:
a socket having an internal face; and
a first fluid passage in fluid communication with the fluid passage of the drill string;
a second member comprising:
a pin formed to fit within the socket of the first member; and
a second fluid passage that communicates with the first fluid passage; and
a removable valve assembly, to control the flow of fluid between the first fluid passage and the second fluid passage, supported in the socket between the internal face and the pin when the pin is positioned within the socket; and
a downhole tool operatively connected to the second member having a fluid outlet in communication with the second fluid passage.

35. The horizontal directional drilling system of claim 34 wherein the internal face comprises an opening of the first fluid passage.

36. The horizontal directional drilling system of claim 34 wherein the first member comprises a second socket disposed at an end opposite the socket, the second socket operatively connected to the second end of the drill string.

37. The horizontal directional drilling system of claim 34 wherein the socket of the first member comprises internal threads.

38. The horizontal directional drilling system of claim 37 wherein the pin of the second member comprises external threads corresponding to the internal threads of the socket.

39. The horizontal directional drilling system of claim 37 wherein a portion of the pin comprises external threads corresponding to the internal threads of the socket.

40. The horizontal directional drilling system of claim 39 wherein the external threads and the internal threads are tapered.

41. The horizontal directional drilling system of claim 34 further comprising:
the first member having a non-circular exterior surface; and
a sleeve having a non-circular profile on an inner surface thereof whereby the sleeve can be slidably mounted on the non-circular exterior surface of the first member.

42. The horizontal directional drilling system of claim 41 wherein the sleeve is fastened to the second member so that the sleeve passes torque from the first member to the second member.

43. The horizontal directional drilling system of claim 41 wherein the pin comprises an external non-circular surface corresponding to the non-circular surface of the first member and the non-circular profile of the sleeve.

44. The horizontal directional drilling system of claim 34 wherein the valve assembly comprises:
a valve seat disposed against the internal face of the socket and a distal end of the pin, the internal face defining an opening of the first fluid passage and the distal end of the pin defining an opening of the second fluid passage;
a valve seated in the valve seat and disposed between the first fluid passage and the second fluid passage to permit the flow of fluid from the first passage to the second passage and reduce the flow of fluid from the second passage to the first passage.

45. The horizontal directional drilling system of claim 44 wherein the valve prevents the flow of fluid from the second fluid passage to the first fluid passage.

46. The horizontal directional drilling system of claim 34 wherein the valve assembly comprises a valve seat and valve disposed in the valve seat.

47. The horizontal directional drilling system of claim 46 wherein the valve comprises a diaphragm valve.

48. The horizontal directional drilling system of claim 46 wherein the valve comprises:
a flange disposed in the valve seat and having an opening;
a circular extension defining a cavity in fluid communication with the opening of the flange;
a slot formed at an end of the circular extension opposing the flange, wherein the slot opens, when fluid passing from the first fluid passage reaches a threshold pressure, to permit fluid to flow to the second fluid passage.

49. The horizontal directional drilling system of claim 34 wherein the downhole tool comprises a beacon housing and drill bit.
